(19) United States
(12) Patent Application Publication
(10) Pub. No.: US 2023/0318489 A1
(43) Pub. Date: Oct. 5, 2023

(54) POWER CONVERTER, MOTOR DRIVER, AND REFRIGERATION CYCLE APPLIED EQUIPMENT

(71) Applicant: Mitsubishi Electric Corporation, Tokyo (JP)

(72) Inventors: Keisuke UEMURA, Tokyo (JP); Tomohiro KUTSUKI, Tokyo (JP); Haruka MATSUO, Tokyo (JP); Koichi ARISAWA, Tokyo (JP); Takaaki TAKAHARA, Tokyo (JP); Kazunori HATAKEYAMA, Tokyo (JP)

(21) Appl. No.: 18/252,414

(22) PCT Filed: Jan. 6, 2021
(86) PCT No.: PCT/JP2021/000193

§ 371 Date: May 10, 2023

(51) Int. Cl. H02M 7/5387; H02M 1/088; H02M 1/00

(52) U.S. Cl. CPC H02M 7/53873; H02M 1/088; H02M 1/0025

(57) ABSTRACT

A power converter includes a converter circuit, a capacitor, and an inverter circuit. The converter circuit includes diodes that are connected in a half-bridge configuration. An alternating-current input end of the converter circuit is connected to one side of an alternating-current power supply. The inverter circuit includes semiconductor switching elements that are connected in a three-phase bridge configuration. An alternating-current output end of the inverter circuit is connected to a motor as a load, and an alternating-current output end is further connected to another side of the alternating-current power supply.

### FIELD

The present disclosure relates to a power converter for converting alternating-current power into desired power, a motor driver, and a refrigeration cycle applied equipment.

### BACKGROUND

Conventionally, there is a power converter for converting a power supply voltage, which is a voltage applied from an alternating-current power supply, into a desired alternating voltage, and applies the alternating voltage to a load such as an air conditioner. For example, Patent Literature 1 discloses a technique in which a power converter that is a control device of an air conditioner rectifies a power supply voltage applied from an alternating-current power supply by a diode stack that is a converter, converts a voltage smoothed by a smoothing unit into a desired alternating voltage by an inverter consisting of a plurality of switching elements, and applies the alternating voltage to a compressor motor as a load.

### CITATION LIST

### Patent Literature

Patent Literature 1: Japanese Patent Application Laid-open No. H7-71805

### SUMMARY

### Technical Problem

However, in the above-described power converter according to the related art, a power supply current flows only in a part of a period of a half cycle of the alternating-current power supply. For this reason, there is a problem that a conduction ratio of the power supply current is low, and a harmonic component included in the power supply current increases. In order to solve this problem, there is a method of adding a power factor improving circuit including a switching element, to increase the conduction ratio of the power supply current, and reducing the harmonic component included in the power supply current. However, when this method is adopted, it is necessary to add the power factor improving circuit including the switching element, and there arises another problem that cost of the apparatus increases and the apparatus becomes large.

The present disclosure has been made in view of the above, and an object thereof is to obtain a power converter capable of controlling an increase in cost and size of the apparatus while suppressing a harmonic component included in a power supply current.

### Solution to Problem

In order to solve the above-described problems and achieve the object, a power converter according to the present disclosure includes a converter circuit, a capacitor, and an inverter circuit. The converter circuit includes first and second diodes that are connected in a half-bridge configuration. In addition, the converter circuit includes a first alternating-current input end and first and second direct-current output ends, and the first alternating-current input end is connected to one side of an alternating-current power supply. The capacitor is connected to the first direct-current output end at one end and connected to the second direct-current output end at another end. The inverter circuit includes a plurality of semiconductor switching elements connected in a three-phase bridge configuration. In addition, the inverter circuit includes first and second direct-current input ends and first to third alternating-current output ends. The first direct-current input end is connected to one end of the capacitor, and the second direct-current input end is connected to another end of the capacitor. The first to third alternating-current output ends are connected to a motor as a load, and the first alternating-current output end is connected to another side of the alternating-current power supply.

### Advantageous Effects of Invention

The power converter according to the present disclosure has an effect of controlling an increase in cost and size of the apparatus while suppressing a harmonic component included in a power supply current.

### BRIEF DESCRIPTION OF DRAWINGS

FIG. 1 is a diagram illustrating a configuration example of a power converter according to a first embodiment.

FIG. 2 is a block diagram illustrating a configuration example of a controller according to the first embodiment.

FIG. 3 is a flowchart for explaining an operation of a voltage command value corrector illustrated in FIG. 2.

FIG. 4 is a view illustrating an analysis result when the controller of FIG. 2 is applied to a circuit configuration of FIG. 1 to control.

FIG. 5 is a block diagram illustrating an example of a hardware configuration that implements functions of the controller in the first embodiment.

FIG. 6 is a block diagram illustrating another example of a hardware configuration that implements functions of the controller in the first embodiment.

FIG. 7 is a diagram illustrating a configuration example of a power converter according to a second embodiment.

FIG. 8 is a diagram illustrating a configuration example of a refrigeration cycle applied equipment according to a third embodiment.

### DESCRIPTION OF EMBODIMENTS

Hereinafter, a power converter, a motor driver, and a refrigeration cycle applied equipment according to embodiments of the present disclosure will be described in detail with reference to the accompanying drawings. Note that, hereinafter, physical connection and electrical connection will not be distinguished from each other, and will be simply referred to as “connection”. That is, the term “connection” includes both a case where components are directly connected to each other and a case where components are electrically connected to each other via another component.

### First Embodiment

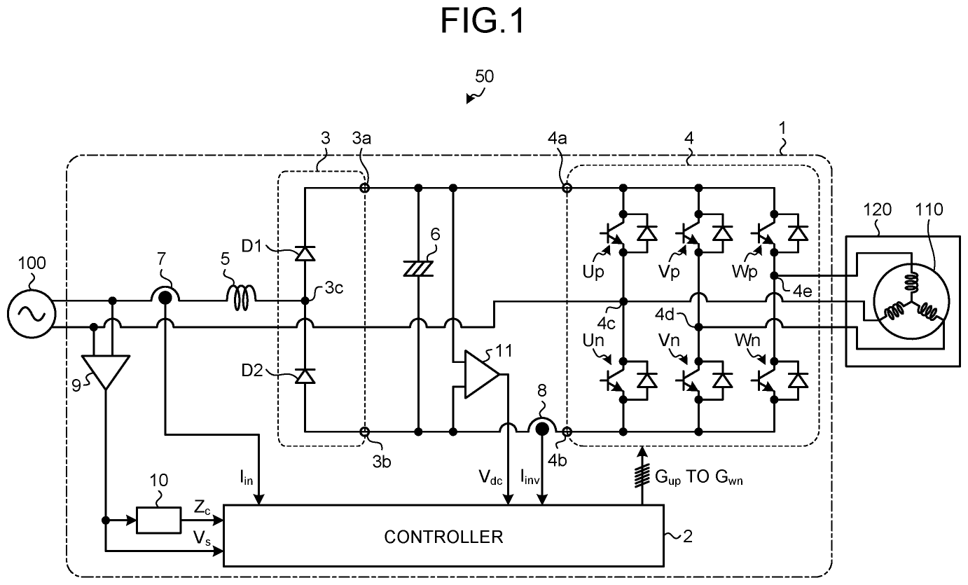

FIG. 1 is a diagram illustrating a configuration example of a power converter 1 according to a first embodiment. The power converter 1 is connected to an alternating-current power supply 100 and a device 120. An example of the device 120 is a compressor, and another example of the device 120 is a fan. The device 120 includes a motor 110. The power converter 1 converts a power supply voltage applied from the alternating-current power supply 100 into an alternating voltage having a desired amplitude and phase, and applies the alternating voltage to the motor 110.

The power converter 1 includes a controller 2, a converter circuit 3, an inverter circuit 4, a reactor 5, a capacitor 6, current detectors 7 and 8, voltage detectors 9 and 11, and a zero gross detector 10. The power converter 1 and the motor 110 included in the device 120 constitute a motor driver 50.

The voltage detector 9 detects a power supply voltage Vs applied from the alternating-current power supply 100 to the converter circuit 3. The zero-cross detector 10 generates a zero-cross signal Zo corresponding to the power supply voltage Vs of the alternating-current power supply 100. For example, the zero-cross signal Zc is a signal for output of a “high” level when the power supply voltage Vs is of positive polarity, and is a signal for output of a “low” level when the power supply voltage Vs is of negative polarity. Note that, these levels may be reversed. A detected value of the power supply voltage Vs and the zero-cross signal Zc are inputted to the controller 2.

The converter circuit 3 includes diodes D1 and D2 that are connected in a half-bridge configuration. Specifically, an anode of the diode D1 is connected to a cathode of the diode D2. Note that, in the present description, the diode D1 may be referred to as a “first diode”, and the diode D2 may be referred to as a “second diode”.

The reactor 5 and the current detector 7 are disposed between the converter circuit 3 and the alternating-current power supply 100. The converter circuit 3 rectifies the power supply voltage Vs applied from the alternating current power supply 100.

The converter circuit 3 includes direct-current output ends 3a and 3b and an alternating-current input end 3c. A connection point of the diodes D1 and D2 connected in series is the alternating-current input end 3c. A cathode of the diode D1 is connected to the direct-current output end 3a, and an anode of the diode D2 is connected to the direct-current output end 3b. The alternating-current input end 3c is connected to one side of the alternating-current power supply 100 via the reactor 5. Note that, in the present description, the direct-current output end 3a may be referred to as a “first direct-current output end”, the direct-current output end 3b may be referred to as a “second direct-current output end”, and the alternating-current input end 3c may be referred to as a “first alternating-current input end”.

The capacitor 6 is connected to output ends of the converter circuit 3. Specifically, one end of the capacitor 6 is connected to the direct-current output end 3a of the converter circuit 3, and another end of the capacitor 6 is connected to the direct-current output end 3b of the converter circuit 3. The capacitor 6 smooths a rectified voltage outputted from the converter circuit 3. Examples of the capacitor 6 include an electric field capacitor and a film capacitor.

The voltage detector 11 is connected to both ends of the capacitor 6. The voltage detector 11 detects a capacitor voltage V_{dc} that is a voltage of the capacitor 6. A detected value of the capacitor voltage V_{dc} is inputted to the controller 2. Note that, the capacitor voltage V_{dc} is also a voltage of a DC bus to which the capacitor 6 is connected. Therefore, the capacitor voltage may be referred to as a “bus voltage”.

The inverter circuit 4 is connected to both ends of the capacitor 6. The inverter circuit 4 includes a plurality of switching elements connected in a three-phase bridge configuration. The plurality of switching elements consist of semiconductor switching elements Up, Vp, and Wp of an upper arm and semiconductor switching elements Un, Vn, and Wn of a lower arm. At both ends of each semiconductor switching element, reflux diodes connected in anti-parallel are provided.

The semiconductor switching element Up and the semiconductor switching element Un are connected in series to constitute a U-phase leg. The semiconductor switching element Vp and the semiconductor switching element Vn are connected in series to constitute a V-phase leg. The semiconductor switching element Wp and the semiconductor switching element Wn are connected in series to constitute a W-phase leg.

The inverter circuit 4 includes direct-current input ends 4a and 4b and alternating-current output ends 4c, 4d, and 4e. The direct-current input end 4a is connected to one end of the capacitor 6, and the direct-current input end 4b is connected to another end of the capacitor 6. Note that, in the present description the direct-current input end 4a may be referred to as a “first direct-current input end”, and the direct-current input end 4b may be referred to as a “second direct-current input end”.

The alternating-current output ends 4c, 4d, and 4e are connected to the motor 110 as a load. Further, the alternating-current output end 4c is connected to another side of the alternating-current power supply 100. With this configuration, the U-phase leg including the alternating-current output end 4c constitutes a full-wave rectifier circuit together with the converter circuit 3. In the U-phase leg, a full-wave rectification operation is performed by a reflux diode connected in anti-parallel to each of the semiconductor switching elements Up and Un.

Note that, FIG. 1 illustrates the configuration in which the alternating-current output end 4c is connected to another side of the alternating-current power supply 100, but the configuration is not limited thereto. Any one of the alternating-current output ends 4d and 4e may be connected to another side of the alternating-current power supply 100. Note that, in the present description, an alternating-current output end connected to another side of the alternating-current power supply 100 may be referred to as a “first alternating-current output end”, and two alternating-current output ends that are not connected to another side of the alternating-current power supply 100 may be individually referred to as a “second alternating-current output end” and a “third alternating-current output end”.

In the inverter circuit 4, the semiconductor switching elements Up to Un are controlled to be turned ON or OFF by drive signals Gᵤₚ to G_{wn} outputted from the controller 2. The inverter circuit 4 turns ON or OFF the semiconductor switching elements Up to Wn, and converts a voltage outputted from the converter circuit and the capacitor 6 into an alternating voltage for applying to the motor 110.

The current detector 7 detects a power supply current Iᵢₙ, which is a current flowing between the alternating-current power supply 100 and the converter circuit 3. The current detector 8 detects an inverter current Iᵢₙᵥ which is a current flowing through the inverter circuit 4. The inverter current Iᵢₙᵥ is also a current flowing between the inverter circuit 4 and the capacitor 6. The power supply current Iᵢₙ and the inverter current Iᵢₙᵥ are inputted to the controller 2.

An example of the device 120 is an air conditioner. When the motor 110 is a motor for driving a compressor, the motor 110 rotates in accordance with an amplitude and a phase of the alternating voltage applied from the inverter circuit 4, to perform a compression operation. Further, when the motor 110 is a motor for driving a fan, the motor 110 rotates in accordance with an amplitude and a phase of the alternating voltage applied from the inverter circuit 4, to perform an air blowing operation.

Next, an operation of the power converter 1 according to the first embodiment will be described.

As described above, according to the power converter 1 according to the first embodiment, the alternating-current output end 4c in the inverter circuit 4 is connected to another side of the alternating-current power supply 100. As a result, in a half cycle in which a polarity of the power supply voltage Vₛ is positive, the power supply voltage Vₛ is short-circuited via the reactor 5 and the diode D1 every time the semiconductor switching element Up is turned ON. Further, in a half cycle in which the polarity of the power supply voltage Vₛ is negative, the power supply voltage Vₛ is short-circuited via the reactor 5 and the diode D2 every time the semiconductor switching element Un is turned ON. A current path by this operation is identical to a current path by a power supply short-circuit operation when a conventional power factor improving circuit is included. Therefore, it is possible to increase a conduction ratio of the power supply current without including the conventional power factor improving circuit. This makes it possible to suppress a harmonic component included in the power supply current. In addition, since it is not necessary to include a conventional power factor improving circuit, an increase in cost and size of the apparatus can be controlled.

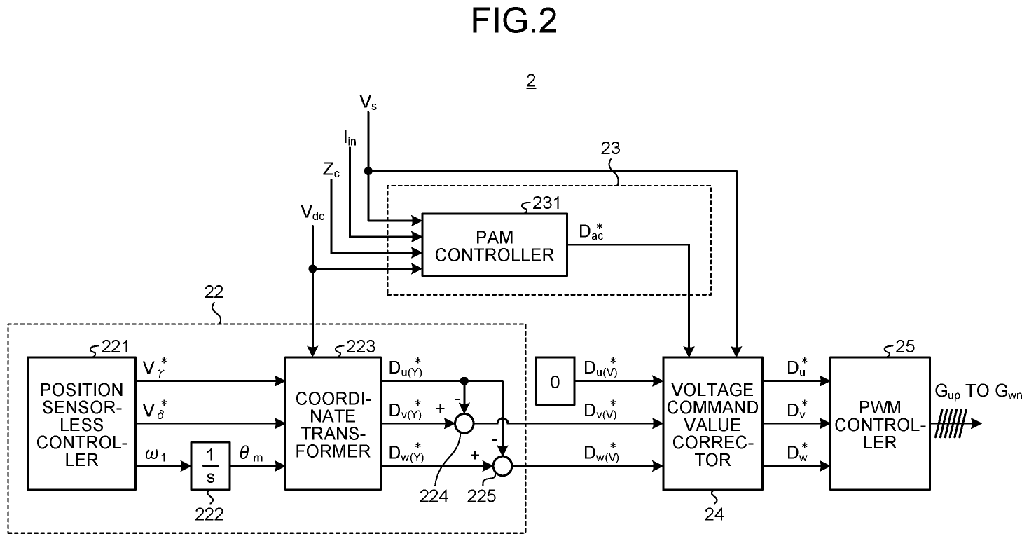

However, the power supply short-circuit operation depends on the ON operation of the semiconductor switching elements Up and Un. Therefore, when a conventional control method of a three-phase inverter is applied as it is, the semiconductor switching elements Up and Un are switched only for performing motor control, and thus, it is impossible to control the power supply current Iᵢₙ. Therefore, the conventional control method of the three-phase inverter is changed. Specifically, the controller 2 is configured as illustrated in FIG. 2, for example. That is, FIG. 2 is a block diagram illustrating a configuration example of the controller 2 according to the first embodiment.

As illustrated in FIG. 2, the controller 2 includes a motor controller 22, a converter output controller 23, a voltage command value corrector 24, and a pulse width modulation (PWM) controller 25. In addition, the motor controller 22 includes a position sensorless controller 221, an integrator 222, a coordinate transformer 223, and subtractors 224 and 225. The converter output controller 23 includes a pulse amplitude modulation (PAM) controller 231.

Here, symbols used in FIG. 2 will be described. “V_{γ}*, V_{δ}*” are a γ-axis voltage command value and a δ-axis voltage command value in a γδ rotating coordinate system, respectively. “ω₁, θₘ” are an estimated value of a rotational speed and an estimated position of a rotor of the motor 110, respectively. “D_{u(Y)}*, D_{v(Y)}*, D_{w(Y)}*” are a U-phase voltage command value, a V-phase voltage command value, and a W-phase voltage command value in a stationary three-phase coordinate system, respectively. “(Y)” means star connection. Hereinafter, the U-phase voltage command value, the V-phase voltage command value, and the W-phase voltage command value are collectively referred to as three-phase voltage command values.

Further, “D_{u(V)}*, D_{v(V)}*, D_{w(V)}*” are three-phase voltage command values equivalent to V connection. Here, “equivalent to the V connection” means that a potential of the alternating-current output end 4c is always fixed to a potential on another side of the alternating-current power supply 100. “D_{ac}*” is a power supply short-circuit duty. The power supply short-circuit duty D_{ac}* is a time ratio of a time of the power supply short-circuit operation to a half cycle of the power supply voltage. “Dᵤ*, Dᵥ*, D_{w}*” are corrected three-phase voltage command values. “Gᵤₚ to G_{wn}” are drive signals for the semiconductor switching elements Up to Wn.

In the motor controller 22, a γδ-axis current of a rotating coordinate system is calculated inside the position sensorless controller 221. Then, a current controller (not illustrated) generates the γ-axis voltage command value V_{γ}* and the δ-axis voltage command value V_{δ}* for matching the γδ-axis current with a command value of the γδ-axis current. Further, in the position sensorless controller 221, the estimated value ω₁ of the rotational speed is generated and inputted to the integrator 222. The integrator 222 integrates the estimated value ω₁ of the rotational speed to generate the estimated position θₘ of the rotor. The coordinate transformer 223 transforms the γ-axis voltage command value V_{γ}* and the δ-axis voltage command value into the three-phase voltage command values D_{u(Y)}*, D_{v(Y)}*, and D_{w(Y)}* in the stationary three-phase coordinate system, on the basis of the estimated position θₘ of the rotor and the capacitor voltage V_{dc}.

In the subtractor 224, the U-phase voltage command value D_{u(Y)}* is subtracted from the V-phase voltage command value D_{v(Y)}*, and a difference value is inputted to the voltage command value corrector 24 as the V-phase voltage command value D_{v(V)}* equivalent to the V connection. Further, in the subtractor 225, the U-phase voltage command value D_{u(Y)}* is subtracted from the U-phase voltage command value D_{w(Y)}*, and a difference value is inputted to the voltage command value corrector 24 as the U-phase voltage command value D_{w(V)}* equivalent to the V connection. Note that, as illustrated in FIG. 2, the U-phase voltage command value D_{u(V)}* equivalent to the V connection is fixed to 0 and inputted to the voltage command value corrector 24.

As described above, the motor controller 22 generates the three-phase voltage command values D_{u(Y)}*, D_{v(Y)}*, and D_{w(Y)}* for controlling the inverter circuit 4. Further, the motor controller 22 also generates the voltage command values D_{v(V)}* and D_{w(V)}* equivalent to the V connection by using the three-phase voltage command values D_{u(Y)}*, D_{v(Y)}*, and D_{w(Y)}*, and outputs to the voltage command value corrector 24.

In the converter output controller 23, the PAM controller 231 generates the power supply short-circuit duty D_{ac}* on the basis of the power supply voltage Vₛ, the capacitor voltage V_{dc}, the power supply current Iᵢₙ, and the zero-cross signal Z_{c}, and outputs the power supply short-circuit duty to the voltage command value corrector 24. The capacitor voltage V_{dc} is referred to for performing bus voltage control. That is, the power supply short-circuit duty D_{ac}* is a command value for performing converter output control including power factor improvement control and bus voltage control.

As described above, the converter output controller 23 generates the power supply short-circuit duty D_{ac}*, which is a control signal for controlling an output of the converter circuit 3, and outputs the power supply short-circuit duty D_{ac}* to the voltage command value corrector 24.

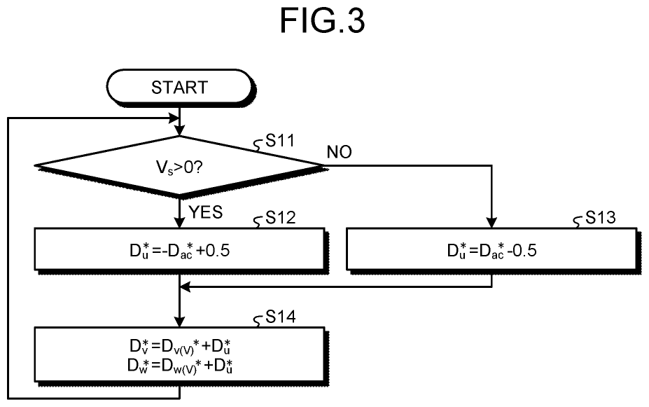

An operation of the voltage command value corrector 24 will be described with reference to FIG. 3. FIG. 3 is a flowchart for explaining an operation of the voltage command value corrector 24 illustrated in FIG. 2.

The voltage command value corrector 24 determines a polarity of the power supply voltage Vₛ (step S11). When the polarity of the power supply voltage Vₛ is positive (step S11, Yes), the corrected U-phase voltage command value Dᵤ* is calculated on the basis of the following Equation (1) (step S12).

Dᵤ*=−D_{ac}*+0.5 (1)

Whereas, when the polarity of the power supply voltage Vₛ is negative (step S11, No), the corrected U-phase voltage command value Dᵤ* is calculated based on the following Equation (2) (step S13).

Dᵤ*=D_{ac}*−0.5 (2)

Note that, when a value of the power supply voltage Vₛ is 0, determination may he made as either positive or negative polarity.

Furthermore, the corrected V-phase voltage command value Dᵥ* and the corrected W-phase voltage command. value D_{w}* are calculated on the basis of the following Equations (3) and (4) (step S14).

Dᵥ*=D_{v(V)}*+Dᵤ* (3)

D_{w}*=D_{w(V)}*+Dᵤ* (4)

As shown in the above Equation (1) or (2), the U-phase voltage command value includes the power supply short-circuit duty D_{ac}*. Therefore, in the inverter circuit 4, a motor control operation and a converter output control operation are simultaneously performed. The “motor control operation” mentioned here is an operation in which the inverter circuit 4 applies a voltage for controlling a rotational speed or a rotational torque of the motor 110, to the motor 110. The motor control operation is performed by switching operations of the six semiconductor switching elements Up to Wn. Further, as described above, the “converter output control operation” includes the power factor improvement control operation and the bus voltage control operation. The converter output control operation is performed by the two semiconductor switching elements Up and Un.

However, in the correction with only the above Equation (1) or (2), an output voltage of the inverter circuit 4 causes three-phase imbalance. Therefore, as shown in the above Equations (3) and (4), the U-phase voltage command value Dᵤ* is added to each of the V-phase voltage command value Dᵥ* and the W-phase voltage command value D_{w}*. By doing in this way, the three-phase imbalance can be resolved.

When the processing of step S14 is completed, the processing returns to step S11. Thereafter, the processing of steps S11 to S14 is repeated.

As described above, the voltage command value corrector 24 performs a process of correcting the voltage command values D_{v(V)}* and D_{w(V)}* equivalent to the V connection, on the basis of the power supply short-circuit duty D_{ac}* as a control signal.

The corrected three-phase voltage command values Dᵤ*, Dᵥ*, and D_{w}* corrected by the voltage command value corrector 24 are inputted to the PWM controller 25. On the basis of the three-phase voltage command values Dᵤ*, Dᵥ*, and D_{w}*, the PWM controller 25 generates the drive signals Gᵤₚ to G_{wn} for driving the semiconductor switching elements Up to Wn.

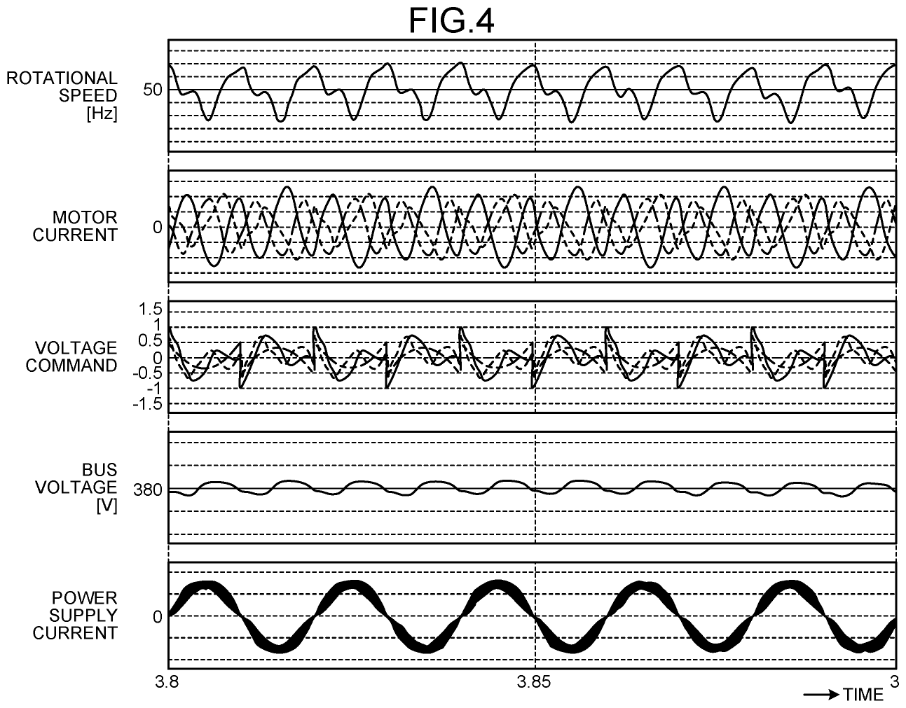

FIG. 4 is a view illustrating an analysis result when the controller 2 of FIG. 2 is applied to the circuit configuration of FIG. 1 for controlling. A horizontal axis in FIG. 4 represents time. In an upper part of FIG. 4, a rotational speed when a command value of the rotational speed is 50 [Hz] is indicated by a solid line. In a middle upper part of FIG. 4, an U-phase current is indicated by a solid line, a V-phase current is indicated by a two-dot chain line, and a W-phase current is indicated by a broken line. In a middle part of FIG. 4, a U-phase voltage command is indicated by a two-dot chain line, a V-phase voltage command is indicated by a broken line, and a W-phase voltage command is indicated by a solid line. In a middle lower part of FIG. 4, a bus voltage when a command value of the bus voltage is 380 [V] is indicated by a solid line. In a lower part of FIG. 4, a fluctuating power supply current is indicated by a solid line.

Referring to waveforms of FIG. 4, it can be seen that the power supply current can also be controlled in a sinusoidal shape while a motor current is maintained in a sinusoidal shape. This has demonstrated that motor control and converter output control can be performed with a smaller number of semiconductor switching elements than before.

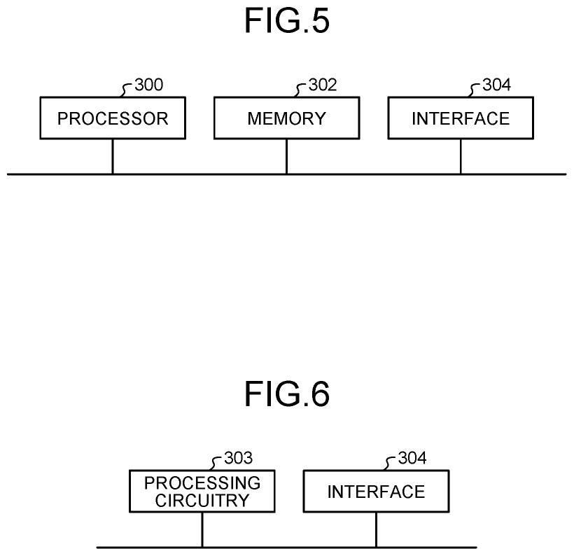

Next, a hardware configuration for implementing functions of the controller 2 in the first embodiment will be described with reference to the drawings of FIGS. 5 and 6. FIG. 5 is a block diagram illustrating an example of a hardware configuration that implements the functions of the controller 2 in the first embodiment. FIG. 6 is a block diagram illustrating another example of a hardware configuration that implements the functions of the controller 2 in the first embodiment.

In a case where some or all of the functions of the controller 2 in the first embodiment are implemented, as illustrated in FIG. 5, a configuration may be adopted including a processor 300 that performs arithmetic operation, a memory 302 that stores a program to be read by the processor 300, and an interface 304 that inputs and outputs signals.

The processor 300 may be an arithmetic means such as an arithmetic device, a microprocessor, a microcomputer, a central processing unit (CPU), or a digital signal processor (DSP). Further, examples of the memory 302 can include a nonvolatile or volatile semiconductor memory such as a random access memory (RAM), a read only memory (ROM), a flash memory, an erasable programmable ROM (EPROM), or an electrically EPROM (EEPROM, registered trademark), a magnetic disk, a flexible disk, an optical disk, a compact disk, a mini disk, and a digital versatile disc (DVD).

The memory 302 stores a program for executing the functions of the controller 2 in the first embodiment. When the processor 300 exchanges necessary information via the interface 304, the processor 300 executes a program stored in the memory 302, and the processor 300 refers to a table stored in the memory 302, the above-described processing can be performed. An operation result by the processor 300 can be stored in the memory 302.

In addition, in a case where some of the functions of the controller 2 in the first embodiment are implemented, processing circuitry 303 illustrated in FIG. 6 can also be used. The processing circuitry. 303 corresponds to a single circuit, a composite circuit, an application specific integrated circuit (ASIC) a field-programmable gate array (FPGA), or a combination of these. Information inputted to the processing circuitry 303 and information outputted from the processing circuitry 303 can be obtained via the interface 304.

Note that some of the processing in the controller 2 may be performed by the processing circuitry 303, and processing that is not performed by the processing circuitry 303 may be performed by the processor 300 and the memory 302.

As described above, the power converter according to the first embodiment includes the converter circuit, the capacitor, and the inverter circuit. The converter circuit includes the first and second diodes that are connected in a half-bridge configuration. In addition, the converter circuit includes the first alternating-current input end and the first and second direct-current output ends, and the first alternating-current input end is connected to one side of the alternating-current power supply. The capacitor is connected to the first direct-current output end of the converter circuit at one end and connected to the second direct-current output end of the converter circuit at another end. The inverter circuit includes a plurality of semiconductor switching elements connected in a three-phase bridge configuration. In addition, the inverter circuit includes the first and second direct-current input ends and the first tn third alternating-current output ends. In the inverter circuit, the first direct-current input end is connected to one end of the capacitor, and the second direct-current input end is connected to another end of the capacitor. In addition, the first to third alternating-current output ends are connected to the motor as a load, and the first alternating-current output end is connected to another side of the alternating-current power supply. According to the power converter according to the first embodiment adapted as described above, it is possible to increase a conduction ratio of a power supply current by appropriately controlling the inverter circuit. This makes it possible to control a increase in cost and size of the apparatus while suppressing a harmonic component included in the power supply current.

### Second Embodiment

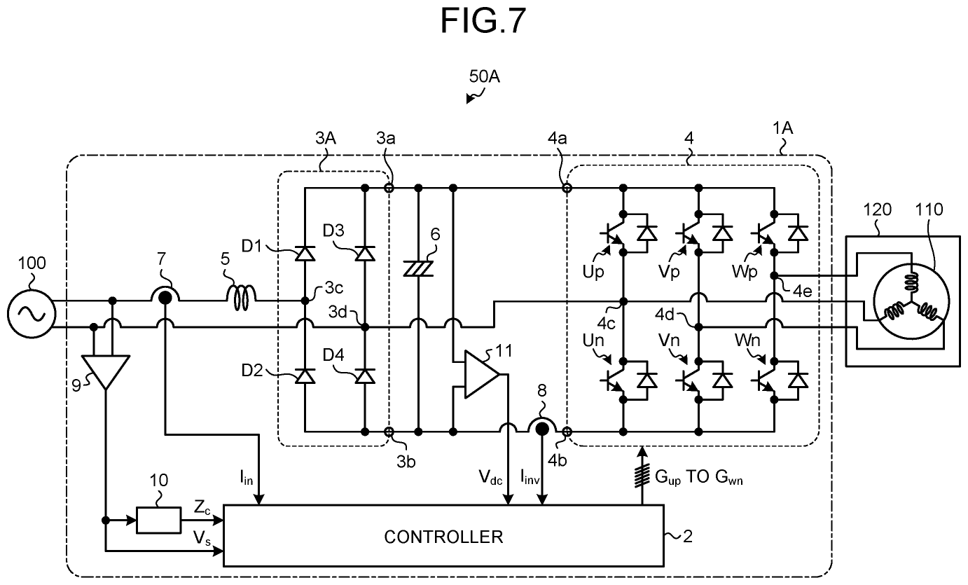

FIG. 7 is a diagram illustrating a configuration example of a power converter 1A according to a second embodiment. In FIG. 7, the converter circuit 3 illustrated in FIG. 1 is replaced with a converter circuit 3A. The power converter 1A and the motor 110 included in the device 120 constitute a motor driver 50A.

In the converter circuit 3A, diodes D3 and D4 that are connected in a half-bridge configuration are added. A connection point of the diodes D3 and D4 is an alternating-current input end 3d. That is, the converter circuit 3A includes the two direct-current output ends 3a and 3b and the two alternating-current input ends 3c and 3d. The alternating-current input end 3d is connected to another side of the alternating-current power supply 100 together with the alternating-current output end 4c in the inverter circuit 4. With this configuration, the diodes D1 and D2 connected in a half-bridge configuration and the diodes D3 and D4 connected in a half-bridge configuration constitute a full-wave rectifier circuit. Other configurations are identical to or equivalent to those of the power converter 1 illustrated in FIG. 1, and identical or equivalent components are denoted by the identical reference numerals, and redundant description is omitted. Note that, in the present description, the alternating-current input end 3d may be referred to as a “second alternating-current input end”.

The diode D3 and a reflux diode of the semiconductor switching element Up have a relationship of being connected in parallel to each other when viewed from. the alternating-current power supply 100. This similarly applies to the diode D4 and a reflux diode of the semiconductor switching element Un. Therefore, the circuit configuration of FIG. 7 is equivalent to the circuit configuration of FIG. 1. Therefore, by applying the controller 2 of FIG. 2 to the circuit configuration of FIG. 7 to control, the effects of the first embodiment described above can be obtained.

Note that the converter circuit 3A illustrated in FIG. 7 is versatile as a circuit that performs full-wave rectification of a single-phase alternating-current. For this reason, there are many commercially available components as a 4-in-1 module in which four diode elements are connected in a full-bridge configuration. Therefore, in order to obtain the effect of cost reduction, the configuration of the power converter 1A of FIG. 7 may be adopted.

As described above, according to the power converter according to the second embodiment, the converter circuit includes the third and fourth diodes that are connected in a full-bridge configuration, together with the first and second diodes. A connection point between the third diode and the fourth diode constitutes the second alternating-current input end, and the second alternating-current input end is connected to another side of the alternating-current power supply. According to the power converter according to the second embodiment configured as described above, by appropriately controlling the inverter circuit, a conduction ratio of a power supply current can be increased. This makes it possible to control an increase in cost and size of the apparatus while suppressing a harmonic component included in the power supply current.

Further, in the power converter according to the second embodiment, the first to fourth diodes included in the converter circuit may be configured as a 4-in-1 module. By using such a 4-in-1 module, the effect of cost reduction can be obtained.

### Third Embodiment

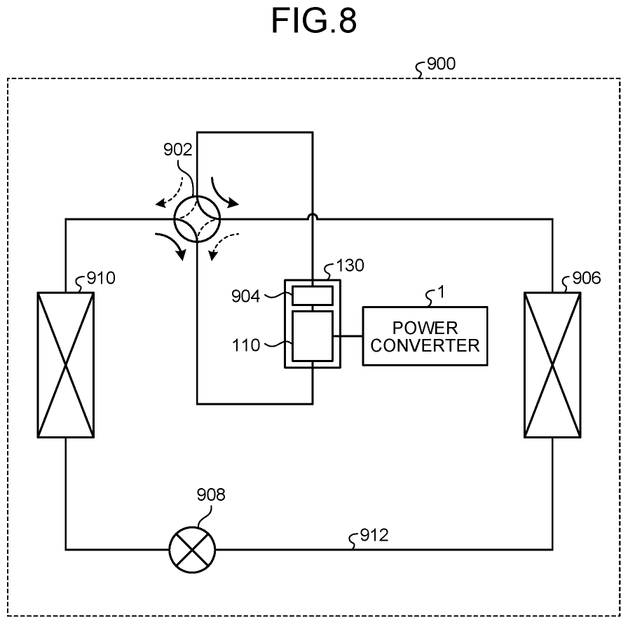

FIG. 8 is a diagram illustrating a configuration example of a refrigeration cycle applied equipment 900 according to a third embodiment. The refrigeration cycle applied equipment 900 according to the third embodiment includes the power converter 1 described in the embodiment. The refrigeration cycle applied equipment 900 according to the first embodiment can be applied to a product including a refrigeration cycle, such as an air conditioner, a refrigerator, a freezer, or a heat pump water heater. Note that, in FIG. 8, components having functions similar to those of the first embodiment are denoted by reference numerals identical to those of the first embodiment.

The refrigeration cycle applied equipment 900 includes a compressor 130 incorporating the motor 110 according to the first embodiment, a four-way valve 902, an indoor heat exchanger 906, an expansion valve 908, and an outdoor heat exchanger 910, which are attached via a refrigerant pipe 912.

Inside the compressor 130, a compression mechanism 904 that compresses a refrigerant and the motor 110 that operates the compression mechanism 904 are provided.

The refrigeration cycle applied equipment 900 can perform heating operation or cooling operation by a switching operation of the four-way valve 902. The compression mechanism 904 is driven by the motor 110 subjected to variable-speed control.

During the heating operation, as indicated by solid arrows, the refrigerant is pressurized and fed by the compression mechanism 904, and returns to the compression mechanism 904 through the four-way valve 902, the indoor heat exchanger 906, the expansion valve 908, the outdoor heat exchanger 910, and the four-way valve 902.

During the cooling operation, as indicated by broken arrows, the refrigerant is pressurized and fed by the compression mechanism 904, and returns to the compression mechanism 904 through the four-way valve 902, the outdoor heat exchanger 910, the expansion valve 908, the indoor heat exchanger 906, and the four-way galve 902.

During the heating operation, the indoor heat exchanger 906 acts as a condenser to release heat, and the outdoor heat exchanger 910 acts as an evaporator to absorb heat. During the cooling operation, the outdoor heat exchanger 910 acts as a condenser to release heat, and the indoor heat exchanger 906 acts as an evaporator to absorb heat. The expansion valve 906 decompresses and expands the refrigerant.

Note that the refrigeration cycle applied equipment 900 according to the third embodiment has been described as including the power converter 1 described in the first embodiment, but the refrigeration cycle applied equipment 900 is not limited thereto, instead the power converter 1A illustrated in FIG. 7 may be included. In addition, a power converter other than the power converters 1 and 1A may be used as long as the control method of the first embodiment can be applied.

The configurations illustrated in the above embodiments illustrate one example and can be combined with another known technique, and it is also possible to combine embodiments with each other and omit and change a part of the configuration without departing from the subject matter of the present disclosure.

### REFERENCE SIGNS LIST

1, 1A power converter; 2 controller; 3, 3A converter circuit; 3a, 3b direct-current output end; 3c, 3d alternating-current input end; 4 inverter circuit; 4a, 4b direct-current input end; 4c, 4d, 4e alternating-current output end; 5 reactor; 6 capacitor; 7, 8 current detector; 9, 11 voltage detector; 10 zero-cross detector; 22 motor controller; 23 converter output controller; 24 voltage command value corrector; 25 PWM controller; 50, 50A motor driver; 100 alternating-current power supply; 110 motor; 120 device; 130 compressor; 221 position sensorless controller; 222 integrator; 223 coordinate transformer; 224, 225 subtractor; 231 PAM controller; 300 processor; 302 memory; 303 processing circuitry; 304 interface; D1, D2, D3, D4 diode; Up, Un, Vp, Vn, Up, Mn semiconductor switching element.

1. A power converter comprising:
a converter circuit comprising first and second diodes connected in a half-bridge configuration, and comprising a first alternating-current input end and first and second direct-current output ends, the first alternating-current input end being connected to one side of an alternating-current power supply;
a capacitor connected to the first direct-current output end at one end and connected to the second direct-current output end at another end; and
an inverter circuit comprising a plurality of semiconductor switching elements connected in a three-phase bridge configuration, and comprising first and second direct-current input ends and first to third alternating-current output ends, the first direct-current input end being connected to the one end, the second direct-current input end being connected to the another end, the first to third alternating-current output ends being connected to a motor as a load, and the first alternating-current output end being connected to another side of the alternating-current power supply, wherein
a full-wave rectifier circuit is configured by the converter circuit and a leg including the first alternating-current output end in the inverter circuit, wherein
the leg is adapted to perform a motor control operation.

2. (canceled)

3. A power converter comprising:
a converter circuit comprising first and second diodes connected in a half-bridge configuration, and comprising a first alternating-current input end and first and second direct-current output ends, the first alternating-current input end being connected to one side of an alternating-current power supply;
a capacitor connected to the first direct-current output end at one end and connected to the second direct-current output end at another end; and
an inverter circuit comprising a plurality of semiconductor switching elements connected in a three-phase bridge configuration, and comprising first and second direct-current input ends and first to third alternating-current output ends, the first direct-current input end being connected to the one end, the second direct-current input end being connected to the another end, the first to third alternating-current output ends being connected to a motor as a load, and the first alternating-current output end being connected to another side of the alternating-current power supply, wherein
the inverter circuit is adapted to simultaneously perform a motor control operation and a converter output control operation.

4. The power converter according to claim 3, wherein
in the inverter circuit, a leg including the first alternating-current output end is adapted to perform the converter output control operation.

5. A power converter comprising:
a converter circuit comprising first and second diodes connected in a half-bridge configuration, and comprising a first alternating-current input end and first and second direct-current output ends, the first alternating-current input end being connected to one side of an alternating-current power supply;
a capacitor connected to the first direct-current output end at one end and connected to the second direct-current output end at another end; and
an inverter circuit comprising a plurality of semiconductor switching elements connected in a three-phase bridge configuration, and comprising first and second direct-current input ends and first to third alternating-current output ends, the first direct-current input end being connected to the one end, the second direct-current input end being connected to the another end, the first to third alternating-current output ends being connected to a motor as a load, and the first alternating-current output end being connected to another side of the alternating-current power supply, wherein
the converter circuit includes third and fourth diodes connected in a full-bridge configuration, together with the first and second diodes, and
a connection point between the third diode and the fourth diode constitutes a second alternating-current input end, and the second alternating-current input end is connected to another side of the alternating-current power supply.

6. The power converter according to claim 5, wherein
the first to fourth diodes are configured as a 4-in-1 module.

7. A power converter comprising:
a converter circuit comprising first and second diodes connected in a half-bridge configuration, and comprising a first alternating-current input end and first and second direct-current output ends, the first alternating-current input end being connected to one side of an alternating-current power supply;
a capacitor connected to the first direct-current output end at one end and connected to the second direct-current output end at another end;
an inverter circuit comprising a plurality of semiconductor switching elements connected in a three-phase bridge configuration, and comprising first and second direct-current input ends and first to third alternating-current output ends, the first direct-current input end being connected to the one end, the second direct-current input end being connected to the another end, the first to third alternating-current output ends being connected to a motor as a load, and the first alternating-current output end being connected to another side of the alternating-current power supply, and
a controller adapted to control an operation of the inverter circuit, wherein
the controller includes:
a motor controller adapted to generate a voltage command value equivalent to V connection for controlling the inverter circuit; and
a converter output controller adapted to generate a control signal for controlling an output of the converter circuit.

8. The power converter according to claim 7, wherein
the controller includes:
a voltage command value corrector adapted to correct a voltage command value equivalent to the V connection based on the control signal.

9. A motor driver comprising the power converter according to claim 1.

10. A refrigeration cycle applied equipment comprising the power converter according to claim 1.

11. A motor driver comprising the power converter according to claim 3.

12. A motor driver comprising the power converter according to claim 5.

13. A motor driver comprising the power converter according to claim 7.

14. A refrigeration cycle applied equipment comprising the power converter according to claim 3.

15. A refrigeration cycle applied equipment comprising the power converter according to claim 5.

16. A refrigeration cycle applied equipment comprising the power converter according to claim 7.
